(19) United States
(12) Patent Application Publication
(10) Pub. No.: US 2025/0109934 A1
(43) Pub. Date: Apr. 3, 2025

(54) MULTI-PHASE INTERFEROMETER FOR 3D METROLOGY

(71) Applicant: Orbotech Ltd., Yavne (IL)

(72) Inventors: Yuri Paskover, Binyamina (IL); Hanina Golan, Rishon Lezion (IL); Ilia Lutsker, Kefar Sava (IL); Nir Turko, Rehovot (IL); Oleg Yermak, Yavne, IL (US); Saki Hakim, Yavne, IL (US)

(21) Appl. No.: 18/477,158

(22) Filed: Sep. 28, 2023

(51) Int. Cl. G01B 9/02; G01N 21/95

(52) U.S. Cl. CPC G01B 9/02041; G01B 9/02083; G01N 21/9501

(57) ABSTRACT

In the system, an illumination source emits light, a first beam splitter directs a portion of the light toward a sample and directs another portion of the light toward a reference surface that reflects the light back to the first beam splitter to be recombined with light reflected by the sample, at least one second beam splitter that directs n portions of the light toward n detectors, each of the n portions of the light having a preset phase shift and n≥2, and a processor receives intensities of the n portions of the light. The processor calculates an interferogram envelope based on the intensities measured by the n detectors as the reference surface moves between a plurality of signal collection positions.

### FIELD OF THE DISCLOSURE

This disclosure relates to metrology systems and, more particularly, to interferometry-based metrology systems.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a semiconductor workpiece (e.g., wafer, substrate, display panel, etc.) using a large number of fabrication processes to form various features and multiple levels of the semiconductor devices. For example, lithography is a semiconductor fabrication process that involves transferring a pattern from a reticle to a photoresist arranged on a semiconductor workpiece. Additional examples of semiconductor fabrication processes include, but are not limited to, chemical-mechanical polishing (CMP), etch, deposition, and ion implantation. Multiple semiconductor devices may be fabricated in an arrangement on a single semiconductor workpiece that are separated into individual semiconductor devices.

Inspection processes are used at various steps during semiconductor manufacturing to detect defects on workpieces to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Metrology processes are also used at various steps during semiconductor manufacturing to monitor and control the process. Metrology processes are different than inspection processes in that, unlike inspection processes in which defects are detected on workpieces, metrology processes are used to measure one or more characteristics of the workpieces that cannot be determined using existing inspection tools. Metrology processes can be used to measure one or more characteristics of workpieces such that the performance of a process can be determined from the one or more characteristics. For example, metrology processes can measure a dimension (e.g., line width, thickness, etc.) of features formed on the workpieces during the process. In addition, if the one or more characteristics of the workpieces are unacceptable (e.g., out of a predetermined range for the characteristic(s)), the measurements of the one or more characteristics of the workpieces may be used to alter one or more parameters of the process such that additional workpieces manufactured by the process have acceptable characteristic(s).

Scanning interferometry is generally a scheme used to measure the height of a sample, where light from a light source is split between two arms: one reference arm reflected by a mirror and another arm interacting with the sample. After recombining the light reflected in both arms on a detector, the relative length of the two arms can be varied by moving either the mirror or the sample, and by recording the changes of light intensity on the detector an envelope can be retrieved, where the maximum of the envelope can be regarded as a measurement of the sample height. However, existing methods can require hundreds of thousands of measurements per scan to capture the envelope for accurate measurement resolution. For example, measurement positions (i.e., movements of the mirror) of less than half or quarter of the wavelength of the light may be required in some instances. Accordingly, these methods can be time consuming and reduce system throughput.

Therefore, what is needed is an interferometry method for more quick and efficient measurements.

### BRIEF SUMMARY OF THE DISCLOSURE

An embodiment of the present disclosure provides a system. The system may comprise an illumination source. The illumination source may be configured to emit light along an illumination path.

The system may further comprise a first beam splitter disposed in the illumination path. The first beam splitter may be configured to direct a portion of the light toward a sample and direct another portion of the light along a reference path. The sample may reflect the light along a collection path.

The system may further comprise a reference surface disposed in the reference path. The reference surface may be configured to reflect the light back to the first beam splitter to be recombined with the light reflected by the sample in the collection path.

The system may further comprise n detectors disposed in the collection path, where n≥2.

The system may further comprise at least one second beam splitter disposed in the collection path. The at least one second beam splitter may be configured to direct n portions of the light toward the n detectors, respectively. Each of the n portions of the light may have a preset phase shift.

The system may further comprise a processor in electronic communication with the n detectors. The processor may be configured to receive intensities of the n portions of the light measured by the n detectors, respectively.

The reference surface may be movable between a plurality of signal collection positions to vary the length of the reference path. The processor may be further configured to calculate an interferogram envelope based on the intensities of the n portions of the light measured by the n detectors at at least some of the plurality of signal collection positions.

In some embodiments, the at least one second beam splitter may comprise at least one polarizing beam splitter configured polarize at least one of the n portions of the light to have the preset phase shift.

In some embodiments, the system may further comprise polarization elements disposed between the at least one second beam splitter and at least one of the n detectors. The polarization elements may be configured polarize at least one of the n portions of the light to have the preset phase shift.

In some embodiments, the processor may be configured to calculate the interferogram envelope based on the intensities of the n portions of the light measured by the n detectors at 3 or more of the signal collection positions.

In some embodiments, the processor may be further configured to determine a height of the sample based on a maximum value of the interferogram envelope.

In some embodiments, the system may further comprise a motor in electronic communication with the processor. The motor may be configured to move the reference surface between the plurality of signal collection positions. The processor may be configured to control at least one of the n detectors to capture measurements at the plurality of signal collection positions.

In some embodiments, the motor may be further configured to move one or more optical components to keep the sample in focus while the reference surface moves between the plurality of signal collection positions.

In some embodiments, the motor may be configured to move the reference surface at a constant speed. The processor may be configured to control the n detectors to capture measurements at different times to create the preset phase shift between each of the n portions of the light.

In some embodiments, the processor may be configured to control the n detectors to capture measurements at different signal collection positions to create the preset phase shift between each of the n portions of the light.

In some embodiments, the n detectors may be positioned such that each of the n portions of the light have the preset phase shift.

Another embodiment of the present disclosure provides a method. The method may comprise emitting light with an illumination source along an illumination path.

The method may further comprise directing a portion of the light toward a sample with a first beam splitter disposed in the illumination path. The sample may reflect the light along a collection path.

The method may further comprise directing another portion of the light along a reference path with the first beam splitter. A reference surface disposed in the reference path may reflect the light back to the first beam splitter and may be recombined with the light reflected by the sample in the collection path.

The method may further comprise directing n portions of the light toward n detectors, respectively, with at least one second beam splitter disposed in the collection path. Each of the n portions of the light may have a preset phase shift and n≥2.

The method may further comprise measuring intensities of the n portions of the light received by the n detectors, respectively.

The method may further comprise moving the reference surface between a plurality of signal collection positions to vary the length of the reference path.

The method may further comprise calculating, using a processor, an interferogram envelope based on the intensities of the n portions of the light measured by the n detectors at at least some of the plurality of signal collection positions.

In some embodiments, the at least one second beam splitter may comprise at least one polarizing beam splitter. The method may further comprise polarizing, with the at least one second beam splitter, at least one of the n portions of the light to have the preset phase shift.

In some embodiments, polarization elements may be disposed between the at least one second beam splitter and at least one of the n detectors. The method may further comprise polarizing, with the polarization elements, at least one of the n portions of the light to have the preset phase shift.

In some embodiments, the method may further comprise moving one or more optical components to keep the sample in focus while the reference surface moves between the plurality of signal collection positions.

In some embodiments, the method may further comprise determining a height of the sample based on a maximum value of the interferogram envelope.

### DESCRIPTION OF THE DRAWINGS

For a fuller understanding of the nature and objects of the disclosure, reference should be made to the following detailed description taken in conjunction with the accompanying drawings, in which:

FIG. 1 is a block diagram of a system according to an embodiment of the present disclosure;

FIG. 2 is a block diagram of a system according to another embodiment of the present disclosure;

FIG. 3 is a block diagram of a system according to another embodiment of the present disclosure;

FIG. 4 is a block diagram of a system according to another embodiment of the present disclosure; and

FIG. 5 is a flow chart of a method according to an embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process, step, and electronic changes may be made without departing from the scope of the disclosure. Accordingly, the scope of the disclosure is defined only by reference to the appended claims.

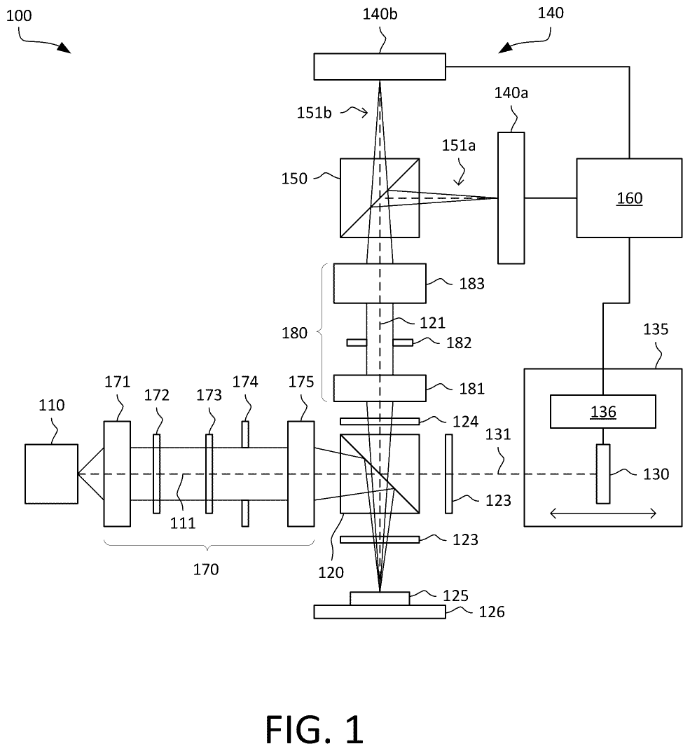

With reference to FIGS. 1-4, an embodiment of the present disclosure provides a system 100. The system 100 may be related to interferometry, 3D metrology, profilometry and/or characterization of optical surfaces in terms of height, single or multi layers thicknesses or refractive index variations based on optical interferometry. For example, the system 100 may be implemented in a 3D metrology tool for automatic optical inspection and review of integrated circuits, flat panel displays, or printed circuit boards. With the system 100, simultaneous or synchronized measurements of an interferogram with defined relations between phases of the measurement may allow for relaxed requirements for mechanical scanning and stability, and can retrieve measurements with sufficient resolution by taking significantly less steps in scan.

The system 100 may comprise an illumination source 110. The illumination source 110 may be configured to emit light along an illumination path 111. The illumination source 110 configured to emit light at a wavelength spectrum of a few nanometers (e.g., 1-10 nm). In some embodiments, the illumination source 110 may emit white light. The illumination source 110 can be configured to emit light with a central wavelength bandwidth as defined by a particular application. The illumination source 110 might be comprised of a broad band emitter, such as an LED or high brightness lamp, and a system allowing for selection of required bandwidth. The latter, without loss of generality, can be either a set (1 or more) of band-pass filters, a set of edge-on and edge-off filters, or a system employing dispersion of the spectrum by either refractive or diffractive element, selection of required band (slit) and recombination of the transmitted band into a single beam.

The system 100 may further comprise a first beam splitter 120. The first beam splitter 120 may be a polarizing beam splitter or a non-polarizing beam splitter. The first beam splitter 120 may be disposed in the illumination path 111. The first beam splitter 120 may be configured to direct a portion of the light toward a sample 125 and direct another portion of the light along a reference path 131. The sample 125 may be a semiconductor workpiece (e.g., wafer, substrate, display panel, etc.) or another object sought to be measured by the system 100. The sample 125 may be disposed on a stage 126. The stage 126 may be movable in-plane (i.e., perpendicular to the incident light) and/or in-axis (i.e., coaxially with the incident light) to adjust which portion of the sample 125 is illuminated for measurement by the system 100. When the light is directed toward the sample 125, the light may be reflected along a collection path 121. Based on the arrangement of the first beam splitter 120 and the sample 125, the illumination path 111 and the collection path 121 may be at oblique angles or collocated with one another. In some embodiments, first beam splitter 120 may be disposed in the collection path 121, such that the light reflected by the sample 125 is transmitted back through the first beam splitter 120.

The system 100 may further comprise a reference surface 130, such as a mirror or any other surface, for comparison to the sample 125. For example, a “golden” sample can be used as the reference surface 130, which can have surface features that are expected to match those of the sample 125 (i.e., the comparison will show deviations in the sample 125 from the expected surface features of the reference surface 130). The reference surface 130 may be disposed in the reference path 131. The reference surface 130 may be configured to reflect the light back to the first beam splitter 120 to be recombined with the light reflected by the sample 125 in the collection path 121. In other words, the illumination source 110 may direct light separately toward the sample 125 and the reference surface 130, and the light reflected by the sample 125 and the reference surface 130 may be recombined in the collection path 121. Based on the arrangement of the first beam splitter 120 and the reference surface 130, the reference path 131 may be arranged such that the light reflected by the reference surface 130 may be collocated with the light incident to the reference surface 130, so that the reflected light is transmitted back to the first beam splitter 120 to be recombined with the collection path 121.

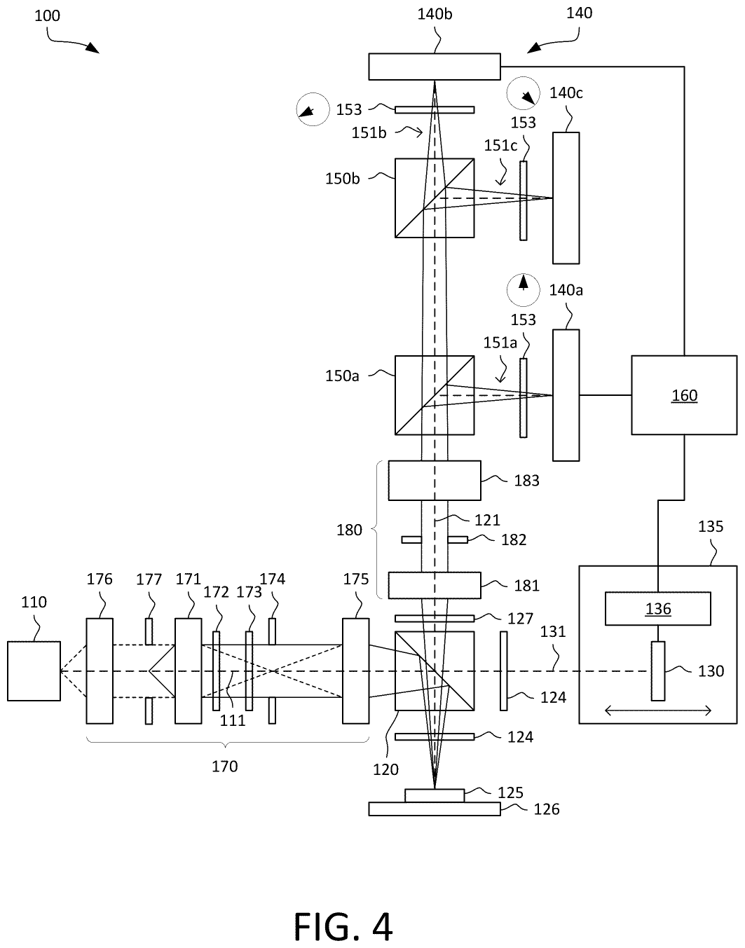

The system 100 may further comprise n detectors 140. In some embodiments, n≥2. For example, as shown in FIGS. 1-4, the n detectors 140 may comprise a first detector 140a and a second detector 140b, and in FIG. 4, the n detectors 140 further comprise a third detector 140c. The first detector 140a, the second detector 140b, and any additional detectors of the n detectors 140 may be disposed in the collection path 121. Each of the n detectors 140 may be a charge coupled device (CCD) camera or other type of detector capable of measuring intensity of the light within the wavelength range of the light emitted by the illumination source 110.

The system 100 may further comprise at least one second beam splitter 150. The at least one second beam splitter 150 may comprise a polarizing beam splitter or a non-polarizing beam splitter. The at least one second beam splitter 150 may be disposed in the collection path 121. The at least one second beam splitter 150 may be configured to direct n portions of the light toward each of the n detectors 140, respectively. For example, as shown in FIGS. 1-4, the n portions of the light may comprise a first portion 151a of the light directed toward the first detector 140a and direct a second portion 151b of the light directed toward the second detector 140b, and in FIG. 4, the n portions of the light further comprise a third portion 151c of the light directed toward the third detector 140c. Additional portions of the light may be directed toward any additional detectors of the n detectors 140 using additional second beam splitters 150 disposed in the collection path 121. For example, for n detectors 140, there may be n 1 second beam splitters 150. In the embodiment shown in FIG. 4, there are two second beam splitters 150a and 150b, in which the second beam splitter 150a directs the first portion 151a of the light toward the first detector 140a and the second beam splitter 150b directs the second portion 151b of the light toward the second detector 140b and directs the third portion 151c of the light toward the third detector 140c. Each of the second beam splitters 150 may be configured such that each of the n portions of the light are substantially equal parts of the light in the collection path 121. For example, the second beam splitter 150a may be a 33/66 beam splitter, in which about ⅓ of the light is directed as the first portion 151a of the light toward the first detector 140a and about ⅔ of the light is directed toward the second beam splitter 150b. The second beam splitter 150b may be a 50/50 beam splitter, in which about ½ of the light is directed as the second portion 151b of the light toward the second detector 140b and about ½ of the light is directed as the third portion 151c of the light toward the third detector 140c. Accordingly, in the embodiment of FIG. 4, each of the n portions of the light may be about ⅓ of the light in the collection path 121. For each additional second beam splitter 150, smaller fractions of the light in the collection path 121 may be split off to each of the n detectors 140. Each of the n portions of the light may have a preset phase shift, based on the arrangement of the components of the system 100 as further described herein. In some embodiments, the n detectors 140 may be positioned such that each of the n portions of the light have a preset phase shift to achieve the preset phase shift.

The system 100 may further comprise a processor 160. The processor 160 may include a microprocessor, a microcontroller, a field programmable gate array (FPGA), or other devices.

The processor 160 may be coupled to the components of the system 100 in any suitable manner (e.g., via one or more transmission media, which may include wired and/or wireless transmission media) such that the processor 160 can receive output. The processor 160 may be configured to perform a number of functions using the output. A metrology or inspection tool can receive instructions or other information from the processor 160. The processor 160 optionally may be in electronic communication with another inspection tool, a metrology tool, or a review tool (not illustrated) to receive additional information or send instructions.

The processor 160 may be part of various systems, including a personal computer system, image computer, FPGA based board and or FPGA extension board to a PC computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 160 may be disposed in or otherwise part of the system 100 or another device. In an example, the processor 160 and may be part of a standalone control unit or in a centralized quality control unit. Multiple processors 160 may be used, defining multiple subsystems of the system 100.

The processor 160 may be implemented in practice by any combination of hardware, software, and firmware including GPU. Also, its functions as described herein may be performed by one unit, or divided up among different components, each of which may be implemented in turn by any combination of hardware, software and firmware. Program code or instructions for the processor 160 to implement various methods and functions may be stored in readable storage media, such as a memory.

If the system 100 includes more than one subsystem, then the different processors 160 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 160 may be configured to perform a number of functions using the output of the system 100 or other output. For instance, the processor 160 may be configured to send the output to an electronic data storage unit or another storage medium. The processor 160 may be further configured as described herein.

The processor 160 may be configured according to any of the embodiments described herein. The processor 160 also may be configured to perform other functions or additional steps using the output of the system 100 or using images or data from other sources.

The processor 160 may be communicatively coupled to any of the various components or sub-systems of system 100 in any manner known in the art. Moreover, the processor 160 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 160 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 160 (or computer subsystem) or, alternatively, multiple processors 160 (or multiple computer subsystems). Moreover, different sub-systems of the system 100 may include one or more computing or logic systems. Therefore, the above description should not be interpreted as a limitation on the present disclosure but merely an illustration.

The processor 160 may be in electronic communication with the n detectors 140. For example, as shown in FIGS. 1-4, the processor 160 is in electronic communication with the first detector 140a and the second detector 140b, and in FIG. 4, the processor 160 is further in electronic communication with the third detector 140c. The processor 160 may be configured to receive intensities of the n portions of light measured by the n detectors 140, respectively. For example, the processor 160 may be configured to receive the intensities of the first portion 151a of the light measured by the first detector 140a, the second portion 151b of the light measured by the second detector 140b, the third portion 151c of the light measured by the third detector 140c, and any additional n portions of the light received by each of the n detectors 140.

The processor 160 may be in electronic communication with a positioning system 135. The positioning system 135 may be configured to move the reference surface 130 to vary the relative length of the reference path 131. For example, the positioning system 135 may comprise a motor 136 configured to move the reference surface 130. In some embodiments, the processor 160 may be further configured to control the positioning system 135 to move the sample 125 to further vary the relative length of the reference path 131. For example, the motor 136 may be in electronic communication with the processor 160, and the processor 160 may be configured to control the motor 136 to stop moving the reference surface 130 when the reference surface 130 is at a plurality of signal collection positions, or the processor 160 may be configured to control the n detectors 140 to collect measurements at the plurality of signal collection positions as the motor 136 continuously moves the reference surface 130. A distance between each signal collection position of the plurality of signal collection positions may correspond to a fraction of the coherence length of the light defined by the spectrum and numerical aperture of the imaging optics of the light, measured by the n detectors 140. It should be understood that while the positioning system 135 moves the reference surface 130, the sample 125 and the stage 126 may remain in the same position, so as to keep the optical response of the sample 125 constant while varying the length of the reference path 131 to vary the optical response of the reference surface 130. In some embodiments, the processor 160 can send instructions to the positioning system 135 to move the optical elements in the collection path 121 (e.g., objective 181 and/or imaging aperture 182) to keep the relevant portion of the sample 125 in focus while scanning using the movement of reference surface 130.

In some embodiments, the motor 136 may be configured to move the reference surface 130 at a constant speed. Accordingly, the processor 160 may be configured to determine the movement of the reference surface 130 based on a period of time that the motor 136 has moved the reference surface 130 at the constant speed. By translating the reference surface 130 at known constant speed, the n detectors 140 can be triggered with a time delta between them, creating a known phase shift between each of the n portions of the light. The time delta may be ¼ of the wavelength of the light or less.

In some embodiments, the motor 136 may be a pulse motion motor. The pulse motion motor may be a stepper motor or a nano-piezo motor. A profiler that generates the motor movement pulses can also generate trigger signals to the n detectors 140 and create the preset phase shift between each of the n portions of the light. For example, motor 136 can include a linear actuator using a closed loop encoder device and a servo motion controller, and the servo motion controller can generate the synchronized pulses for the illumination source 110 and each of the n detectors 140. Accordingly, the processor 160 may be configured to determine the movement of the reference surface 130 based on the rotation of the motor 136, and the n detectors 140 may be triggered with a position difference between them, creating a known phase shift between each of the n portions of the light.

In some embodiments, the system 100 may further comprise a position encoder in electronic communication with the processor 160. The position encoder configured to determine when the motor 136 has moved the reference surface 130 to one of the plurality of signal collection positions. Accordingly, the processor 160 may be configured to control the motor 136 to stop moving the reference surface 130 after moving to each of the signal collection positions and/or control the n detectors 140 to capture measurements. For example, an electronics comparator can be used generate trigger signals for each of the n detectors 140 based on the location of the reference surface 130, and by using n such comparators, each of the n detectors 140 can be triggered at different locations, thus providing a preset phase shift between the measurements.

The processor 160 may be further configured to determine a height of the sample 125 based on calculating the inteferogram envelope driven from the intensity measured by the n detectors 140 among the plurality of signal collection positions.

In general, I(z) is the intensity at each detector measured at mirror z,

$${k}_{z} = \frac{2 π n}{λ}$$

is the wavevector of the light in direction of the scan, λ is the vacuum wavelength of the light, and n is the refractive index of the medium of propagation. The intensity I(z) can be written as an envelope function (z) multiplied by a carrier fringe: cos k₀z: I(z)=ε(z) cos k₀z+C, where C is a constant.

The standard way to measure the interferogram is to scan z in steps

$$Δ z < \frac{π}{2 {k}_{0}}$$

to have at least 2 measurements per fringe cycle. This results in step sizes typically of less than 100 nm. After de-modulating the signal, by utilizing multiple measurements over every fringe cycle, one can retrieve the envelope, and the maximum of the envelope can be regarded as the sample height. However, these small steps require tens to hundreds of thousands of measurement points to measure a sample height having adequate resolution.

In contrast, the system 100 is based on simultaneous, or precisely timed measurement of small sets of points in well-defined carrier phase relations to each other. These sets of points can be used to determine local values of the envelope, and taken in distances allowing to retrieve the shape of the envelope, but not requiring to follow the carrier all along the scan.

In an example, the n detectors 140 may comprise a first detector 140a and a second detector 140b having a defined phase shift of π/2, which can be established by any of the system arrangements and methods described herein. Accordingly, the intensity measured at the first detector 140a may be I₁(z)=ε(z) cos ϕ+C, and the intensity measured at the second detector 140b may be

$${I}_{2} ( z ) = ℰ ( z ) cos ( ϕ - \frac{π}{2} ) + C = ℰ ( z ) sin ϕ + C .$$

Using these two measurements, the envelope function can be written as ε(z)={square root over (I₁(z)−C)²+(I₂(z)−C)²)}.

Alternatively, extending measurement to more than two points spaced in a range of nearly constant envelope:

$$∀ z ∈ [ {z}_{l} : {z}_{h} ] \frac{\partial ℰ ( z )}{\partial z} < \frac{1}{λ}$$

and measuring a set of points {zᵢ} over a z-range small enough to assume ε(z)˜const∀z∈[zₗ, zₕ], one could fit the signal to a harmonic function, for instance:

$$S ( {z}_{i} ) = A cos \frac{2 π {z}_{i}}{λ} + B sin \frac{2 π {z}_{i}}{λ} + C .$$

In such a representation:

$${〈 {ℰ}^{2} ( z ) 〉 \vert}_{[ {z}_{l} : {z}_{h} ]} = \sqrt{{A}^{2} + {B}^{2}} .$$

By fitting the envelope function (z) retrieved over multiple regions to a common function, a maximum to be determined at sufficiently accurate level of resolution. In other words, the processor 160 may be configured to determine the height of the sample 125 based on a maximum value of ε(z) calculated using the respective intensity values I₁(z) and I₂(z) measured at at least some of the plurality of signal collection positions. For example, the processor 160 may trigger signal collection at 100 or more discrete steps per millimeter of movement, but only some of these points may be needed to determine the interferogram function ε(z) and its maximum.

Based on the preset phase shift between the first detector 140a and the second detector 140b, each signal collection position may provide different measurement responses at the first detector 140a and the second detector 140b. Thus, the measurement responses at the first detector 140a and the second detector 140b may represent different data points, and the data points collected at only a few of the plurality of signal collection positions need to be used to determine the interferogram function ε(z). In some embodiments, measurements at 3 or more of the plurality of signal collection positions may be used to determine the interferogram function ε(z) and its maximum. In other words, while the positioning system 135 may scan the reference surface 130 across hundreds of positions, and the first detector 140a and the second detector 140b may detect the intensity of the light received at each of the positions, the measurements at only 3 or more of these positions may be used to determine the interferogram function ε(z) and its maximum. The processor 160 may be configured to determine the height of the sample 125 based on a maximum value of the interferogram function ε(z). While this example refers to the use of two detectors, the n detectors 140 may comprise additional detectors (e.g., 3 or more) and is not limited herein. In such instances, each of the n portions of the light may have preset phase shifts between them, thus the measurement responses at each of the n detectors 140 may represent different data points, and increasing the number of detectors increases the number of data points. Accordingly, the use of additional detectors may further improve measurement fidelity and accuracy of the determined interferogram function ε(z).

In some embodiments, the preset phase shift between the n detectors may be established by polarizing at least one of the n portions of the light directed toward each of the n detectors 140. As further described below, different arrangements of polarizing optics in the system 100 may achieve the preset phase shift. While an exemplary 90° preset phase shift is described, other preset phase shifts may be used and are believed to be within the scope of the present disclosure.

In some embodiments, the at least one second beam splitter 150 may comprise a polarizing beam splitter, as shown in FIG. 1. Accordingly, the at least one second beam splitter 150 may be configured polarize at least one of the first portion 151a of the light and the second portion 151b of the light to have a preset phase shift when it splits the light in the collection path 121. For example, the at least one second beam splitter 150 may be configured to polarize only one of the first portion 151a of the light or the second portion 151b of the light, while the polarization of the other portion(s) of light is not affected by the at least one second beam splitter 150. Alternatively, the at least one second beam splitter 150 may be configured to polarize both the first portion 151a of the light and the second portion 151b of the light in different directions, thereby providing the preset phase shift between the two portions of light. In instances where more than two detectors are used, the additional second beam splitter(s) 150 disposed in the collection path 121 may also be polarizing beam splitter(s) in order to polarize the additional n portions of the light to the other of the n detectors 140.

In some embodiments, the system may further comprise polarization elements 123 disposed in the illumination path 111 between the first beam splitter 120 and the sample 125 and in the reference path 131 between the first beam splitter 120 and the reference surface 130, as shown in FIG. 1. The polarization elements 123 may be configured to polarize the light reflected by the sample 125 and the light reflected by the reference surface 130. Accordingly, the light in the collection path 121 may comprise light in two or more polarization states to be split by the second beam splitter 150. The polarization elements 123 may polarize the light at +22.5°, +45°, or +90°, or any angles therebetween. In the embodiment shown in FIG. 1, the polarization elements 123 include a 45° polarizer in the illumination path 111 between the first beam splitter 120 and the sample 125 and a 90° polarizer in the reference path 131 between the first beam splitter 120 and the reference surface 130. In this embodiment, the first beam splitter 120 may be a non-polarizing beam splitter.

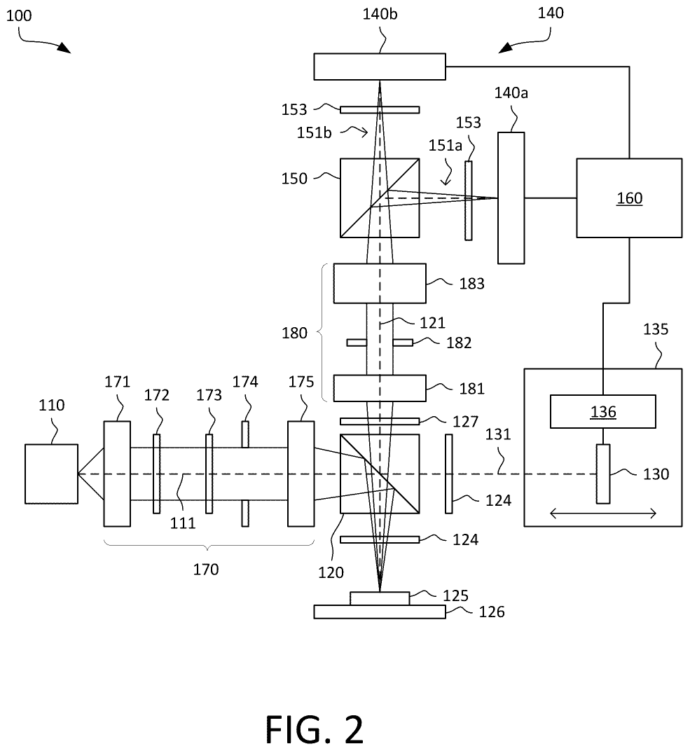

In some embodiments, the first beam splitter 120 may be a polarizing beam splitter, as shown in FIG. 2. Accordingly, the first beam splitter 120 may be configured to polarize at least one of the portion of the light directed toward the sample 125 and the portion of the light directed along the reference path 131 toward the reference surface 130. For example, the first beam splitter 120 may be configured to polarize only one of portion of the light directed toward the sample 125 and the portion of the light directed along the reference path 131 toward the reference surface 130, while the polarization of the other portion of light is not affected by the first beam splitter 120.

Alternatively, the first beam splitter 120 may be configured to polarize both the portion of the light directed toward the sample 125 and the portion of the light directed along the reference path 131 toward the reference surface 130, thereby providing the preset phase shift between the two portions of light. The light in the collection path 121 may therefore comprise light in two or more polarization states based on the light reflected by the sample 125 and the light reflected by the reference surface 130 being in different polarization states.

In some embodiments, the system 100 may further comprise polarization elements 153 disposed between the at least one second beam splitter 150 and at least one of the n detectors 140. For example, as shown in FIG. 2, polarization elements 153 may be disposed between the at least one second beam splitter 150 and each of the first detector 140a and the second detector 140b. The polarization elements 153 may be configured polarize at least one of the first portion 151a of the light and the second portion 151b of the light to have a preset phase shift after the at least one second beam splitter 150 has split the light in the collection path 121. The polarization elements 153 may polarize the light at +22.5°, +45°, or +90°, or any angles therebetween. In the embodiment shown in FIG. 2, the polarization elements 153 include a 22.5° polarizer in the first portion 151a of the light between the second beam splitter 150 and the first detector 140a and a −22.5° polarizer in the second portion 151b of the light between the second beam splitter 150 and the second detector 140b. In this embodiment, the at least one second beam splitter 150 may be a non-polarizing beam splitter. In the embodiment shown in FIG. 4, the polarization elements 153 are disposed in each of the first portion 151a of the light, the second portion 151b of the light, and the third portion 151c of the light, such that all three portions of the light have the preset phase shift (shown as arrows adjacent to each of the polarization elements 153).

In some embodiments, the system 100 may further comprise wave plates 124 disposed in the illumination path 111 between the first beam splitter 120 and the sample 125 and in the reference path 131 between the first beam splitter 120 and the reference surface 130. The wave plates 124 may be quarter wave plates or half wave plates. In the embodiment shown in FIG. 2, the wave plates 124 are quarter wave plates.

The system 100 may further comprise a wave plate 127 disposed in the collection path 121 between the first beam splitter 120 and the at least one second beam splitter 150. In the embodiments shown in FIGS. 1-4, the wave plate 127 is a quarter wave plate.

The system 100 may further comprise an illumination optical assembly 170 disposed in the illumination path 111 between the illumination source 110 and the first beam splitter 120. The illumination optical assembly 170 may comprise one or more optical elements such as a condenser 171, a polarizer 172, a spectral filter 173, an illumination aperture 174, and a collector 175 disposed in downstream order in the illumination path 111 in the direction of the light emitted from the illumination source 110 toward the first beam splitter 120.

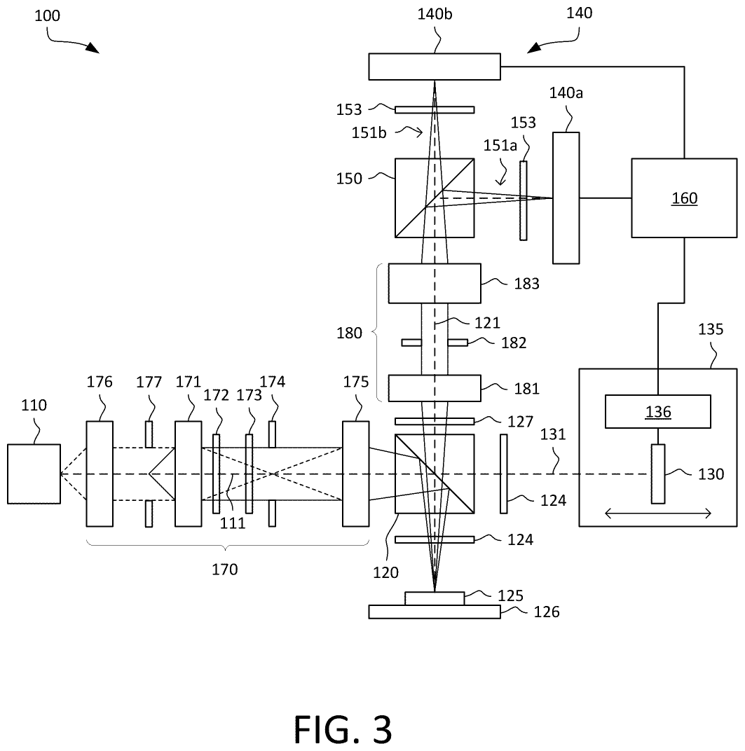

In some embodiments, the illumination optical assembly 170 may further comprise a second condenser 176 and an illumination field stop 177 disposed in downstream order in the illumination path 111, upstream of the condenser 171, as shown in FIG. 3. The addition of the second condenser 176 and the illumination field stop 177 may provide Kohler illumination. While the embodiment of FIG. 3 is the same as the embodiment of FIG. 2 with the additional elements in the illumination optical assembly 170, such elements could also be added to the embodiment of FIG. 1 to provide Kohler illumination. Likewise, while the embodiment of FIG. 4 includes the additional elements in the illumination optical assembly 170 which may provide Kohler illumination, such elements may be omitted to only include the optical elements shown in the embodiment of FIG. 1.

The system 100 may further comprise a collection optical assembly 180 disposed in the collection path 121 between the first beam splitter 120 and the at least one second beam splitter 150. The collection optical assembly 180 may comprise an objective 181, an imaging aperture 182, and a tube lens 183 in downstream order in the collection path 121 in the direction of the recombined light reflected by the sample 125 and the reference surface 130 toward the second beam splitter 150.

With the system 100, the height of the sample 125 can be determined using a small number of points over the envelope (e.g., three or more), which reduces the total number of measurements by a factor of 10 to 100 compared to existing systems. The n detectors 140 are synchronized with a preset phase shift based on time-delayed triggering of the detectors, a position difference of the reference surface 130, or a polarization difference between the light received by each detector, such that the detectors provide pairs of measurement points to determine the interferogram envelope function using only a few measurements and calculate a maximum value of the envelope that corresponds to the height of the sample 125. Such efficiencies allow for increased throughput, while maintaining the precision for accurate measurements.

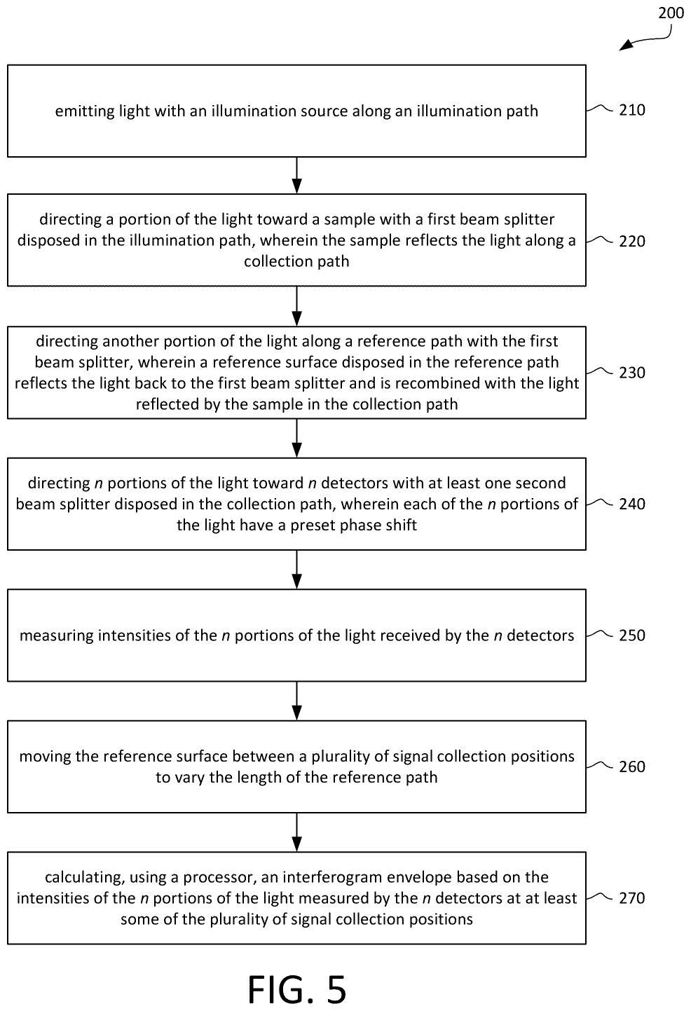

An embodiment of the present disclosure provides a method 200. With reference to FIG. 5, the method 200 may comprise the following steps.

At step 210, an illumination source emits light along an illumination path. The illumination source may be configured to emit light at a wavelength spectrum selected based on a particular measurement application. For example, the wavelength spectrum may be a few nanometers (e.g., 1-10 nm). In some embodiments, the illumination source may emit white light. The illumination source can be configured to emit light with a central wavelength bandwidth as defined by particular application. The illumination source might be comprised of a broad band emitter, such as LED or high brightness lamp, and a system allowing for selection of required bandwidth. The latter, without loss of generality, can be either set (1 or more) of band-pass filters, set of edge-on and edge-off filters, or a system employing dispersion of the spectrum by either refractive or diffractive element, selection of required band (slit) and recombination of the transmitted band into a single beam.

At step 220, a first beam splitter disposed in the illumination path directs a portion of the light toward a sample, and the sample reflects the light along a collection path. The sample may be a semiconductor workpiece (e.g., wafer, substrate, display panel, etc.) or another object sought to be measured. Based on the arrangement of the first beam splitter and the sample, the illumination path and the collection path may be at oblique angles or collocated with one another. In some embodiments, first beam splitter may be disposed in the collection path, such that the light reflected by the sample is transmitted back through the first beam splitter.

At step 230, the first beam splitter directs another portion of the light along a reference path, and a reference surface disposed in the reference path reflects the light back to the first beam splitter and is recombined with the light reflected by the sample in the collection path. The reference surface may be a mirror or any surface for comparison to the sample. For example, a “golden” sample can be used as the reference surface, which can have surface features that are expected to match those of the sample (i.e., the comparison will show deviations in the sample from the expected surfaces features of the reference surface). Based on the arrangement of the first beam splitter and the reference surface, the reference path may be arranged such that the light reflected by the reference surface may be collocated with the light incident to the reference surface, so that the reflected light is transmitted back to the first beam splitter to be recombined with the collection path.

At step 240, at least one second beam splitter disposed in the collection path directs n portions of the light toward n detectors, respectively. Each of the n portions of the light have a preset phase shift. In some embodiments, the n detectors may be positioned such that each of the n portions of the light have the preset phase shift. In other embodiments, the optical components may polarize at least one of the n portions of the light to create the preset phase shift.

At step 250, the n detectors measure intensities of the n portions of the light. Each of the n detectors may be a charge coupled device (CCD) camera or other type of detector capable of measuring intensity of the light within the wavelength range of the light emitted by the illumination source. Each of the n detectors may capture measurements at slightly different times to cause the preset phase shift. Alternatively, each of the n detectors may capture measurements simultaneously, but they receive polarized light having the preset phase shift.

At step 260, the reference surface moves between a plurality of signal collection positions to vary the length of the reference path. For example, a positioning system may be configured to move the reference surface between the plurality of signal collection positions. The positioning system may comprise a motor that is configured to move the reference mirror to perform measurements at each of the plurality of signal collection positions. A distance between each position of the plurality of signal collection positions may correspond to a fraction of the coherence length of the light defined by the spectrum and numerical aperture of the imaging optics of the light, measured by each of the n detectors, respectively. In some embodiments, the reference surface may move to 100 or more signal collection positions to perform measurements. Based on the preset phase shift between the n detectors, each signal collection position may provide different measurement responses at the n detectors. Thus, the measurement responses at the n detectors may represent different data points, and the data points collected at only a few of the plurality of signal collection positions need to be used to determine an interferogram envelope.

At step 270, a processor calculates an interferogram envelope based on the intensities of the n portions of the light measured by the n detectors at at least some of the plurality of signal collection positions. For example, the processor may generate the interferogram envelope based on the measurements from the n detectors at 3 or more of the signal collection positions, and a maximum of the interferogram envelope may be used to determine the height of the sample.

With the method 200, the height of the sample can be determined using a small number of points over the envelope (e.g., 3 or more), which reduces the total number of measurements by a factor of 10 to 100 compared to existing systems. The n detectors are synchronized with a preset phase shift based on time-delayed triggering of the detectors, a position difference of the reference surface, or a polarization difference between the light received by each detector, such that the n detectors provide sets of measurement points to determine the interferogram envelope using only a few measurements and calculate a maximum value of the envelope that corresponds to the height of the sample. Such efficiencies allow for increased throughput, while maintaining the precision for accurate measurements.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

1. A system comprising:
an illumination source configured to emit light along an illumination path;
a first beam splitter disposed in the illumination path and configured to direct a portion of the light toward a sample and direct another portion of the light along a reference path, wherein the sample reflects the light along a collection path;
a reference surface disposed in the reference path and configured to reflect the light back to the first beam splitter to be recombined with the light reflected by the sample in the collection path;
n detectors disposed in the collection path, where n≥2;
at least one second beam splitter disposed in the collection path and configured to direct n portions of the light toward the n detectors, respectively, wherein each of the n portions of the light have a preset phase shift; and
a processor in electronic communication with the n detectors that is configured to receive intensities of the n portions of the light measured by the n detectors, respectively;
wherein the reference surface is movable between a plurality of signal collection positions to vary the length of the reference path, and the processor is further configured to calculate an interferogram envelope based on the intensities of the n portions of the light measured by the n detectors at at least some two of the plurality of signal collection positions.

2. The system of claim 1, wherein the at least one second beam splitter comprises at least one polarizing beam splitter configured polarize at least one of the n portions of the light to have the preset phase shift.

3. The system of claim 1, further comprising polarization elements disposed between the at least one second beam splitter and at least one of the n detectors, wherein the polarization elements are configured polarize at least one of the n portions of the light to have the preset phase shift.

4. The system of claim 1, wherein the processor is configured to calculate the interferogram envelope based on the intensities of the n portions of the light measured by the n detectors at 3 or more of the signal collection positions.

5. The system of claim 1, wherein the processor is further configured to determine a height of the sample based on a maximum value of the interferogram envelope.

6. The system of claim 1, further comprising a motor in electronic communication with the processor and configured to move the reference surface between the plurality of signal collection positions, wherein the processor is configured to control at least one of the n detectors to capture measurements at the plurality of signal collection positions.

7. The system of claim 6, wherein the motor is further configured to move one or more optical components to keep the sample in focus while the reference surface moves between the plurality of signal collection positions.

8. The system of claim 6, wherein the motor is configured to move the reference surface at a constant speed, and the processor is configured to control the n detectors to capture measurements at different times to create the preset phase shift between each of the n portions of the light.

9. The system of claim 6, wherein the processor is configured to control the n detectors to capture measurements at different signal collection positions to create the preset phase shift between each of the n portions of the light.

10. The system of claim 1, wherein the n detectors are positioned such that each of the n portions of the light have the preset phase shift.

11. A method comprising:
emitting light with an illumination source along an illumination path;
directing a portion of the light toward a sample with a first beam splitter disposed in the illumination path, wherein the sample reflects the light along a collection path;
directing another portion of the light along a reference path with the first beam splitter, wherein a reference surface disposed in the reference path reflects the light back to the first beam splitter and is recombined with the light reflected by the sample in the collection path;
directing n portions of the light toward n detectors, respectively, with at least one second beam splitter disposed in the collection path, wherein each of the n portions of the light have a preset phase shift and n≥2;
measuring intensities of the n portions of the light received by the n detectors, respectively;
moving the reference surface between a plurality of signal collection positions to vary the length of the reference path; and
calculating, using a processor, an interferogram envelope based on the intensities of the n portions of the light measured by the n detectors at at least two of the plurality of signal collection positions.

12. The method of claim 11, wherein the at least one second beam splitter comprises at least one polarizing beam splitter, and the method further comprises:
polarizing, with the at least one second beam splitter, at least one of the n portions of the light to have the preset phase shift.

13. The method of claim 11, wherein polarization elements are disposed between the at least one second beam splitter and at least one of the n detectors, and the method further comprises:
polarizing, with the polarization elements, at least one of the n portions of the light to have the preset phase shift.

14. The method of claim 11, wherein the processor is configured to calculate the interferogram envelope based on the intensities of the n portions of the light measured by the n detectors at 3 or more of the signal collection positions.

15. The method of claim 11, wherein the processor is configured to control at least one of the n detectors to capture measurements at the plurality of signal collection positions.

16. The method of claim 11, further comprising:
moving one or more optical components to keep the sample in focus while the reference surface moves between the plurality of signal collection positions.

17. The method of claim 11, wherein the processor is configured to control the n detectors to capture measurements at different times to create the preset phase shift between the n portions of the light.

18. The method of claim 11, wherein the processor is configured to control the n detectors to capture measurements at different signal collection positions to create the preset phase shift between the n portions of the light.

19. The method of claim 11, wherein the n detectors are positioned such that each of the n portions of the light have the preset phase shift.

20. The method of claim 11, further comprising:
determining a height of the sample based on a maximum value of the interferogram envelope.

21. The system of claim 1, wherein n≥3.

22. The method of claim 11, wherein n≥3.

23. The system of claim 6, wherein the motor is configured only to move the reference surface between the plurality of signal collection positions.
